(19) United States
(12) Patent Application Publication
(10) Pub. No.: US 2007/0051547 A1
(43) Pub. Date: Mar. 8, 2007

(54) Method for assisting the driver during driving maneuvers

(75) Inventors: Eckard Fischer, Stuttgart (DE); Helmut Keller, Korb (DE); Jakob Seiler, Frankfurt am Main (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/568,151

(22) PCT Filed: Aug. 4, 2004
(86) PCT No.: PCT/EP04/08719

§ 371 Date: Oct. 26, 2006

(30) Foreign Application Priority Data
Aug. 12, 2003 (DE) 103 36 985.6

(51) Int. Cl. B60S 9/00

(52) U.S. Cl. 180/204

(57) ABSTRACT

A method for assisting the driver of a vehicle (10) during a driving maneuver such as, for example, a parking or positioning maneuver. In such a case, a reference trajectory (16) along which the vehicle (10) is to be moved is determined. A steering wheel position which is to be set and which steers the vehicle along the reference trajectory (16) is indicated to the driver during the driving maneuver. A steering angle deviation between the actual steering angle which is actually set by the driver and the setpoint steering angle which corresponds to the requested steering wheel position is corrected independently of the driver.

The invention relates to a method for assisting the driver of a vehicle during driving maneuvers according to the preamble of patent claim 1.

Such a method is disclosed, for example, in DE 198 09 416 A1, which discloses a method for assisting the driver when parking. The parking strategy is communicated to the driver during the driving maneuver by means of a visual display device, an audible voice output device or a haptic steering wheel so that the driver can park in the parking space by following the parking strategy.

The method of the generic type has the disadvantage that the reactions of the driver to the indications of the steering wheel position to be set cannot be predicted. The driver is integrated into the control loop and constitutes, as it were, an interference variable. In particular in the case of difficult driving maneuvers such as, for example, parking in reverse into a parking space at the edge of a road parallel to the edge of the road (referred to as parallel parking), it is difficult for the driver to set the steering wheel position respectively requested by the instruction during the driving maneuver.

It is therefore the object of the present invention to develop a method and a device for carrying out the method of the generic type in such a way that it is made easier for the driver to set the steering wheel position requested by means of the instruction.

This object is achieved by means of the features of patent claims 1 and 14.

According to the invention, a steering angle deviation between the actual steering angle which is actually set by the driver by means of the steering wheel and the setpoint steering angle which corresponds to the requested steering wheel position is corrected, for example compensated for, automatically by the driver independently of the actuation of the steering wheel.

If there is a steering angle deviation, during the driving maneuver the vehicle deviates from the ideal line predefined by the reference trajectory. The driver then has the steering task of setting the actual steering angle according to the predefined value in order to arrive at the desired target position. In order to make this task easier for him, steering angle deviations are corrected automatically. This considerably increases the driver's comfort.

Advantageous refinements of the method according to the invention and of the device according to the invention emerge from the dependent patent claims.

The driver-independent correction of the steering angle deviation (d_{LW}) takes place in particular only if the steering angle deviation (d_{LW}) lies within a predefined steering angle correction range. The driver is thus not completely relieved of the need to carry out the steering task but rather the actual steering angle is merely corrected if a steering angle deviation occurs. The steering angle correction range may, for example, be selected in such a way that the actual steering angle is not increased or decreased above a predefined maximum correction value, for example ±5°.

The longitudinal velocity (v) of the vehicle can be influenced independently of the driver when there is a steering angle deviation (d_{LW}) which lies outside the steering angle correction range. The longitudinal velocity of the vehicle is then, in particular, reduced in order to give the driver sufficient time to steer the vehicle back into a vehicle position which is predefined by the reference trajectory.

The longitudinal velocity is advantageously influenced as a function of the absolute value of the steering angle deviation. The greater the steering angle deviation, the more intensely is the vehicle retarded in order to reduce the vehicle longitudinal velocity.

A steering angle tolerance range which defines the permissible steering angles can be determined during the driving maneuver as a function of the current position of the vehicle, and the influencing of the longitudinal velocity of the vehicle can depend on the tolerance interval between the requested setpoint steering angle to be set by the driver and the tolerance range limits. The smaller the tolerance interval between the setpoint steering angle and a tolerance range limit, the more intensely must the vehicle velocity be reduced if, by means of the steering wheel position, the driver sets an actual steering angle which lies between the setpoint steering angle and the respective tolerance range limit.

Here there is the possibility of determining a rotational angle tolerance range in order to acquire the steering angle tolerance range, wherein the current rotational angle between the longitudinal axis of the vehicle and a coordinate axis of a fixed coordinate system is increased or decreased until it is still just possible to determine a trajectory with respect to the target position by computation. During the determination of the trajectory, the same acquisition method can be used as for the determination of the reference trajectory at the starting point of the vehicle. In this case, so to speak, two limiting trajectories would be calculated which, as viewed in the driving maneuver direction of travel starting from the current vehicle position, represent a maximum possible left-hand limiting trajectory and a maximum possible right-hand limiting trajectory, along which the vehicle can still be moved to the target position. In this case, the determination of the limiting trajectories also depends on the minimum radius which can be traveled along owing to the vehicle geometry, and whether there are obstacles in the vehicle surroundings which have to be passed.

The larger the absolute value of the steering angle deviation and/or the smaller the absolute value of the tolerance interval, the smaller is the vehicle longitudinal velocity selected and set by means of appropriate open-loop or closed-loop control interventions.

The vehicle is advantageously decelerated to the stationary state and held in the stationary state as long as, owing to the steering angle deviation which is present, the vehicle would, when continuing to travel, assume a vehicle position from which the target position can no longer be reached without interrupting the positioning of the driving maneuver. If no or only very small rotational angle deviations from the current rotational angle of the vehicle may be permitted with respect to the current position of the vehicle, a very low value is predefined for the vehicle longitudinal velocity and the vehicle is immediately brought to a stationary state if the driver predefines a steering wheel position which, if the vehicle continues to travel with this steering wheel position which is predefined by the driver, will place the vehicle in a vehicle position from which it would not be possible to determine a trajectory to the target position any longer. This ensures that the vehicle maneuver is not interrupted by positioning maneuvers and has to be started again from the beginning. Starting from the stationary state, the vehicle is accelerated again if a steering angle deviation which is acceptable or which can be corrected automatically is present and thus an acceptable actual steering angle has been set by the driver.

The steering wheel position which is to be set is advantageously communicated to the driver by audible information to the driver and/or visual information to the driver and/or haptic information to the driver. In order to provide the driver with haptic information, for example the steering wheel torque can be varied. In this context it is, for example, conceivable for the rotation of the steering wheel to the requested steering wheel position to be made easier and/or for the rotation away from the requested steering wheel position to be made more difficult. For this purpose, it is possible, for example, to use the servomotor which is already present in any case in a power steering system.

The driving maneuver which is to be carried out may be, for example, a parking maneuver, in which case the reference trajectory indicates the ideal path from the initial position of the vehicle or the current position of the vehicle to the desired parked position. In particular in the case of parking maneuvers it is desirable to assist the driver in particular inexperienced car drivers or car drivers who are not accustomed to a new vehicle or a vehicle which is used rarely. The driving maneuvers in question are generally those with a vehicle longitudinal velocity below a velocity threshold value of, for example, 10 km/h.

It is furthermore advantageous, if, in the case of a vehicle in the trailer mode, each position of the vehicle along the reference trajectory is assigned a setpoint bending angle between the longitudinal axis of the vehicle and the longitudinal axis of the trailer, and if the current bending angle is determined and is compared with the corresponding setpoint bending angle, in which case the longitudinal velocity of the vehicle is influenced independently of the driver when there is an angular deviation between the setpoint bending angle and the current bending angle. Here, in addition an angular deviation between the setpoint bending angle and current bending angle is taken into account. When there is angular deviation between the current bending angle and the setpoint bending angle it is also possible to carry out a velocity closed-loop control process as a function of the absolute value of the angular deviation. Furthermore it would also be possible to select larger values for the driver-independent deceleration of the vehicle, the greater the absolute value of the angular deviation.

The invention will be explained in more detail below with reference to the appended drawing, in which:

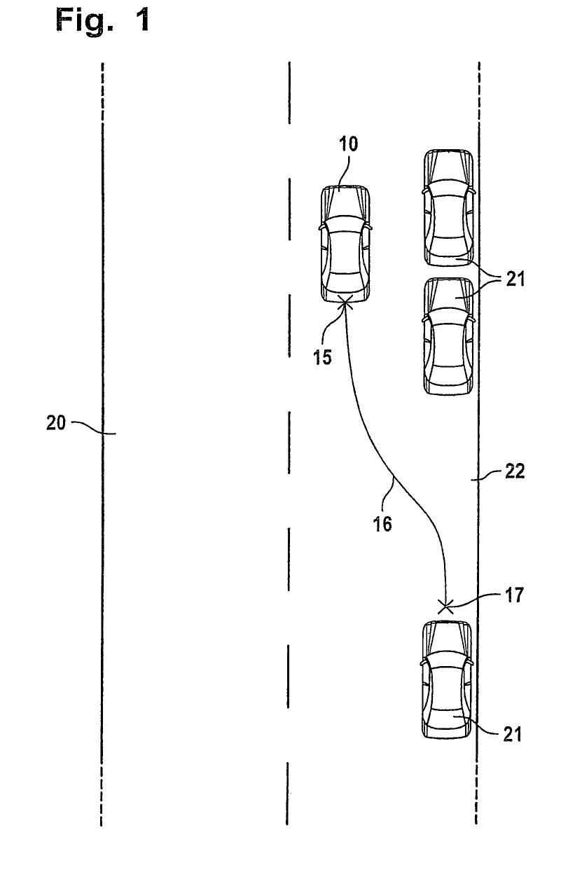

FIG. 1 shows a schematic representation of a desired trajectory and the limiting trajectories for a parking maneuver in plan view,

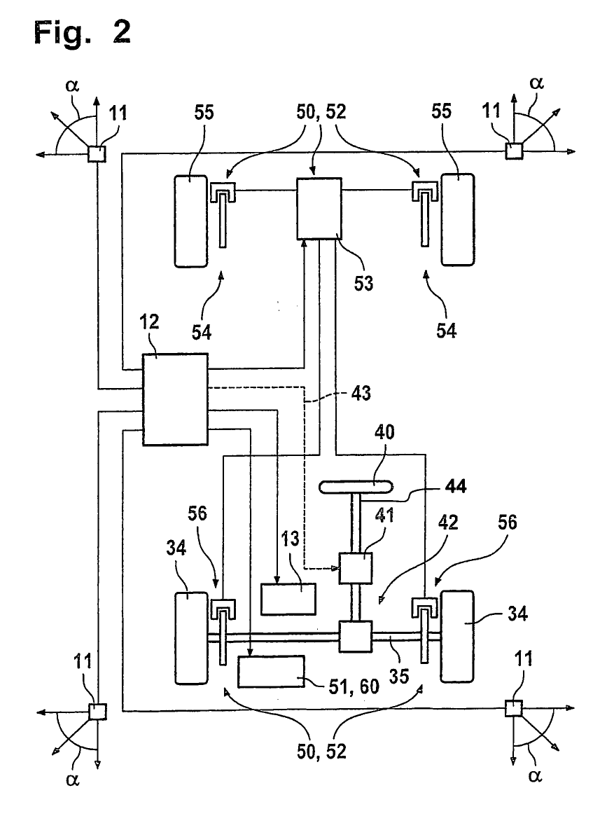

FIG. 2 shows a representation in the manner of a block diagram of an exemplary embodiment of a device for assisting the driver during a driving maneuver,

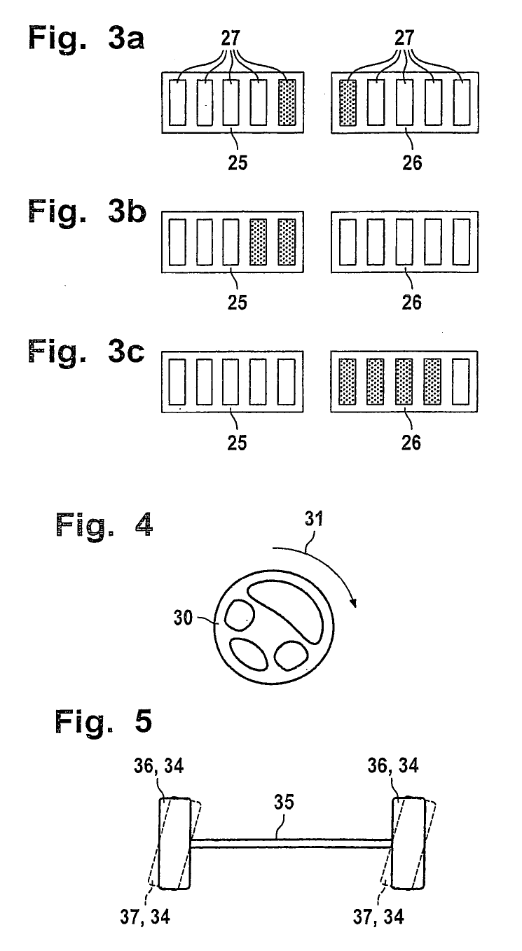

FIGS. 3a-3c show a first embodiment of a visual display for the steering wheel position to be set for the driver,

FIG. 4 shows a second embodiment of a visual display for the steering wheel position to be set for the driver,

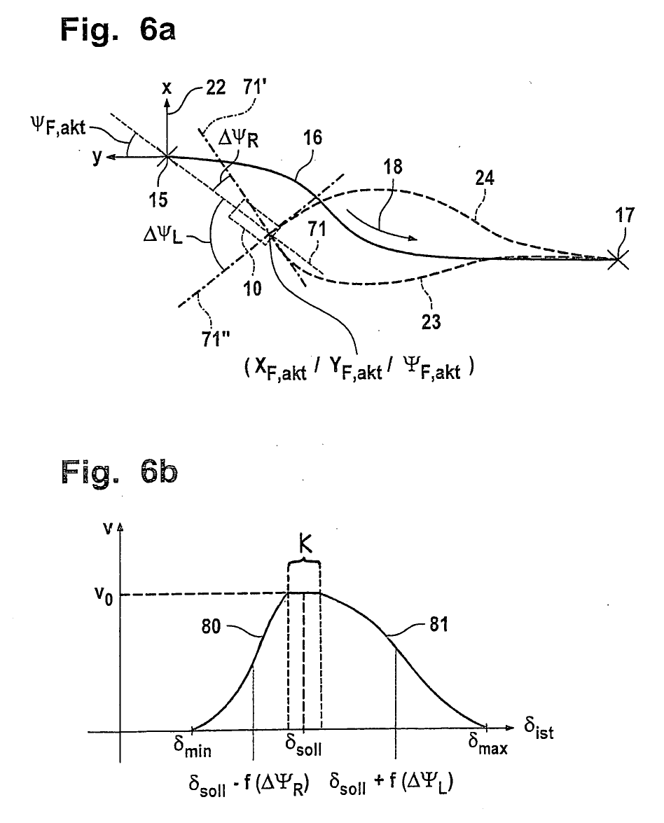

FIG. 5 shows a third embodiment of a visual display for the steering wheel position to be set for the driver,

FIG. 6a shows a reference trajectory and the limiting trajectories at a specific time during a driving maneuver,

FIG. 6b shows a diagram relating to the situation illustrated in FIG. 6a, the vehicle longitudinal velocity v being plotted as a function of the actual steering angle δᵢₛₜ, and

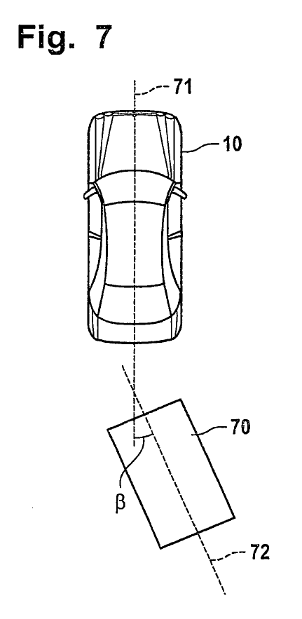

FIG. 7 shows a schematic representation of a vehicle in the trailer mode in plan view.

The invention relates to a method and a device for assisting the driver of a vehicle 10 during a driving maneuver. Such a driving maneuver may be, for example, a parking maneuver, a positioning maneuver or the like, in which case the vehicle 10 can be operated in solo mode or in trailer mode with the trailer attached. For example, the driver can also be supported when driving straight backward in the trailer mode.

During parking maneuvers, parking spaces are firstly measured by means of a suitable sensor system, for example by means of ultrasonic sensor units 11, while the vehicle 10 is passing by, and an evaluation is carried out to determine whether the parking space is sufficiently large for a parking maneuver. In the exemplary embodiment according to FIG. 2, four ultrasonic sensor units 11 are provided for this purpose, and each of these can be arranged in a corner region of the vehicle 10. Any desired number of ultrasonic sensors 11 may be present and this number also depends in particular on how large the emission angle α is at which the sensor waves are emitted and the reflected waves are received. As an alternative to the ultrasonic sensor units 11, radar sensor or lasers sensors can also be employed.

The evaluation of the sensor data from the ultrasonic sensor units 11 is carried out in an evaluation unit 12 in which it is established whether the measured parking space is sufficiently large to park the vehicle. The evaluation result can be displayed to the driver by a display device 13.

The measurement of the parking spaces and the evaluation of the measured results can either be carried out continuously below a predefinable velocity threshold or, alternatively, only when the driver has entered a corresponding request, for example by means of the combined instrument.

If a sufficiently large parking space has been sensed, the driver can initiate the assistance method according to the invention by means of an appropriate operating request. One possibility, after a suitable parking space has been found, is for the driver to be asked automatically—for example by means of the combined instrument—whether he wishes to have parking assistance. The driver then merely needs to confirm the question to activate the assistance method according to the invention. Another possibility is that, after a suitable parking space has been found, the assistance method is actuated automatically when the vehicle is stopped within a predefineable time interval and the reverse gear is selected.

FIG. 1 shows a typical situation for a parking maneuver of a vehicle 10 at the edge of a road 20 between other parked vehicles 21. The vehicle 10 has traveled on the road 20 along the row of parked vehicles 21 and, as it travels past, has sensed that there is a sufficiently large parking space 22, by means of the ultrasonic sensor units 11 and the evaluation device 12. This has been communicated to the driver by means of the display device 13 and the driver has stopped the vehicle.

Depending on the starting position 15 of the vehicle 10 assumed at the start of the driving maneuver, a reference trajectory 16 which represents the ideal line is determined in the evaluation device 12 in order to move the vehicle from its starting position 15 into a target or parked position 17. The reference trajectory 16 thus represents the ideal path to be covered, leading from the starting position 15 to the target position 17.

Methods for determining the reference trajectory 16 are known, for example, from DE 29 01 504 B1, DE 38 13 083 A1 or DE 199 40 007 A1. Reference is made expressly at this point to the known methods for determining the reference trajectory 16.

When the reference trajectory is determined, the minimum distances (such as the minimum distance in the longitudinal direction of the vehicle, minimum distance in the transverse direction of the vehicle) which the vehicle which is to be moved along the reference trajectory has to maintain from obstacles, are varied as a function of the length of the parking space which is found. That is to say that, for example, the larger values can be selected for the minimum distances from objects, the longer the parking space. As a result, when the driver parks he can be provided with the largest possible room for maneuver in order to make the tolerable deviations of the actual position of the vehicle from the reference trajectory as large as possible. This increases the comfort of the driver.

From the start of the driving maneuver with the vehicle 10 located in the starting position 15, the driver is automatically asked whether he wishes assistance for the following parking maneuver, the driver being able to decline or accept the assistance by means of a corresponding input.

If the driver requests the automatic assistance for the driving maneuver in accordance with the method according to the invention, the steering wheel position to be set or the steering wheel angle which is to be set and which would move the vehicle along the current reference trajectory 16 is indicated to him by means of the display device 13.

FIGS. 3-5 show various examples of visual representations which can be displayed to the driver by means of the display device 13. The first exemplary embodiment of a visual display according to FIGS. 3a- 3c is a type of bar display. A left-hand bar 25 indicates when the steering wheel is to be turned to the left, and a right-hand bar 26 indicates when the driver should turn the steering wheel to the right. The greater the steering wheel angle which the driver has to set, the greater is also the left-hand bar 25 or the right-hand bar 26 which is displayed. In the exemplary embodiment, the two bars 25, 26 are formed by a plurality of light-emitting means, for example light-emitting diodes, located horizontally one beside the other. The more light-emitting diodes of a bar 25, 26 which light up, the greater the requested steering wheel angle. Of course, alternatively the type of bar display could also be represented by an LC display, not specifically illustrated, of the display device 13. It would also be possible to use as the display device 13 the bar display which is already present in contemporary vehicles and displays the distance from an obstacle during parking.

In FIG. 3a the respective first light-emitting diode 27 of the two bars 25, 26, which is arranged adjacent to the respective other bar 25 or 26, lights up. In FIG. 3 the light-emitting diodes 27 that light up are represented schematically by a dot pattern. If the first light-emitting diode 27 of the two bars 25, 26 lights up in each case, this signals to the driver that he is to maintain the currently set steering wheel angle unchanged. As an alternative to this, an individual zero-point light-emitting diode could also be provided between the two bars 25, 26 which lights up when the steering wheel position is to remain unchanged.

In FIG. 3b, by means of two light-emitting diodes of the left-hand bar 25 lighting up, it is indicated to the driver that he is to rotate the steering wheel slightly to the left. As soon as the requested steering wheel position has been reached, the display which is illustrated and described above in FIG. 3a appears again. In FIG. 3c, by means of four light-emitting diodes of the right-hand bar 26 lighting up, a larger steering wheel lock to the right is requested of the driver.

In principle any desired number of light-emitting diodes 27 which form a bar 25, 26 can be selected and said number is coordinated in such a way that the driver can be given a sufficiently fine subdivision in the requirement for the steering wheel position to be set. According to the example, each bar 25, 26 contains five light-emitting diodes 27.

By means of the display device 13 it is possible, in addition or as an alternative, to also display further representations which indicate the steering wheel position to be set to the driver. FIG. 4 shows, for example, a stylized steering wheel representation 30 in combination with a direction arrow 31, which can be communicated to the driver by means of an LC display of the display device 13, the steering wheel representation 30 and the direction arrow 31 indicating the requested direction of rotation or the requested steering wheel angle. In FIG. 4, a slight steering wheel lock to the right is requested of the driver by means of the steering wheel representation 30 and the direction arrow 31.

A further embodiment of a visual representation for requesting a steering wheel position to be set is shown in FIG. 5. Here, the vehicle wheels 34 of the steerable front axle 35 are illustrated schematically. The wheel position represented by the continuous lines is the current wheel position 36 of the vehicle wheels 34, while the dashed illustration indicates the requested setpoint position 37 of the steered vehicle wheels 34. The driver must accordingly move the steering wheel into a position in which the setpoint position 37 of the vehicle wheels 34 corresponds to the current wheel position 36.

Of course, instead of the different illustration of setpoint position 37 and current wheel position 36 of the vehicle wheels 34 by lines, it is also possible to choose different colors if the display device 13 has a color LC display.

It is possible not only to use one or more of the described visual display possibilities to indicate the steering wheel position to be set to the driver, but also as an alternative or in addition the audible information to the driver and/or haptic information to the driver indicating the steering wheel angle to be set can also be issued.

The audible information to the driver may be issued by voice output using, for example, loudspeakers (not illustrated in more detail) in the vehicle. The haptic information to the driver can be conveyed by means of the steering wheel. It is possible in such a case to increase the steering wheel torque to be applied by the driver for a direction of rotation away from the requested steering wheel position and/or to decrease the steering wheel torque to be applied by the driver in a position of rotation toward the requested steering wheel position. Consequently, through the steering wheel torque to be applied the driver can experience the direction of rotation in which he must move the steering wheel in order to set the requested steering wheel position, by which means haptic information to the driver for indicating the steering wheel position to be set is implemented.

In order to correct the actual steering angle δᵢₛₜ, automatically, the evaluation device 12 is connected to a servomotor 41 of the power steering system 42 in order to actuate it, as is indicated by the dot-dashed connecting line 43 in FIG. 2. As a result, the actual steering angle δᵢₛₜ can be corrected by the evaluation device 12 by actuating the servomotor 41 via the steering column 44. In a modification with respect to the illustrated exemplary embodiment, the servomotor 41 and the part of the steering column 44 which is connected to the steering wheel 40 can be connected to the inputs of a variable ratio gear unit of the power steering system 42, the input variables of the servomotor 41 and of the steering wheel 40 being summed in the variable ratio gear unit to form an output variable. This output variable is set at the steered vehicle wheels 34 by means of the part of the steering column 44 which is connected to the steered vehicle wheels 34.

According to the example, this driver-independent correction of the steering angle by means of the servomotor 41 takes place only if the steering angle deviation d;hd LW lies within a steering angle correction range K so that fully automatic steering along the reference trajectory 16 does not take place but instead small steering angle deviations dLw are merely corrected in order to increase the driver's comfort.

During the driving maneuver, depending on the respective current vehicle position x_{F,akt}/y_{F,akt}/ψ_{F,akt} the positional deviation of the vehicle 10 from that determined via the reference trajectory 16 is sensed and the steering wheel position which is to be set and which reduces the positional deviation, so that the vehicle is returned to a route corresponding to the reference trajectory, is displayed to the driver by means of the display device 13. Alternatively, it is basically also possible to compensate for the positional deviation automatically.

The current vehicle position x_{F,akt}/y_{F,akt}/ψ_{F,akt} of the vehicle 10 is to be understood not just as the vehicle position x_{F,akt}/y_{F,akt}/ψ_{F,akt} in the coordinate plane in relation to a stationary coordinate system 22 of the road 20 but also the vehicle position includes the alignment of the vehicle longitudinal axis 71 in relation to the coordinate system 22. For example, the rotational angle ψ_{F} is formed between the y axis of the coordinate system 22 and the longitudinal axis 71 of the vehicle. The setpoint rotational angle consequently corresponds to the tangent to the reference trajectory 16.

At the start of the driving maneuver and during the driving maneuver, a right-hand limiting trajectory 23 and a left-hand limiting trajectory 24 are additionally calculated in the evaluation device 12 in the direction of travel 18 of the driving maneuver. The limiting trajectories 23, 24 depend on the current vehicle position x_{F,akt}/y_{F,akt}/ψ_{F,akt}. They indicate, viewed in the direction of travel 18 of the driving maneuver, the two trajectories along which the vehicle 10 can still just be steered from the current vehicle position x_{F,akt}/y_{F,akt} to the target position 17. The right-hand limiting trajectory 23 is obtained by successively increasing the current rotational angle ψ_{F,akt}—in the mathematically positive sense—to an upper limiting rotational angle ψ_{F,max}, with which a trajectory, the right-hand limiting trajectory 23, to the target position 17 can just still be calculated. In this context, the values of the current vehicle position x_{F,akt}/y_{F,akt} remain unchanged.

In an analogous fashion, the lower limiting rotational angle ψ_{F,min} is determined by successively reducing the current rotational angle ψ_{F,akt} until the left-hand limiting trajectory 24 to the target position 17 can just still be determined.

This results in the following equations:
ψ_{F,max}=ψ_{F,akt}+Δψ_{L} a.
and
ψ_{F,min}=ψ_{F,akt}−Δψ_{R}, b.

Δψ_{L} indicating the value by which the current rotational angle has been increased and Δψ_{R} indicating the value by which the current rotational angle has been reduced in order to obtain the respective limiting rotational angles.

These limiting trajectories 23, 24 are determined, for example, with the algorithm which is used to calculate the reference trajectory 16. For example, the limiting trajectories 23, 24 are determined cyclically during the driving maneuver. In order to reduce the computational complexity, one limiting trajectory 23 or 24 is calculated during one computational cycle and the respective other limiting trajectory 24 or 23 is calculated during the following computational cycle. The accuracy in this procedure is completely adequate. Compared with the algorithm used for determining the reference trajectory, further simplifications can be permitted in order to reduce the computational complexity. For instance, the limiting trajectories can be assembled simply from path curves, such as circular sections, which require less computational complexity.

In the text which follows, the manner in which the actual steering angle δᵢₛₜ and the longitudinal velocity v of the vehicle are influenced when there is a steering angle deviation d_{LW} between the actual steering angle δᵢₛₜ which is actually set by the driver and the setpoint steering angle δₛₒₗₗ, which corresponds to the requested steering wheel position to be set will be explained with reference to FIGS. 6a and 6b.

At the time being considered, the vehicle 10 is in the current vehicle position which is described by the values x_{F,akt}/y_{F,akt}/ψ_{F,akt} in relation to the coordinate system 22 of which the origin is located in the starting position 15. The determination of the upper limiting rotational angle ψ_{F,max} and of the lower limiting rotational angle ψ_{F,min} will be explained with reference to this current position x_{F,akt}/y_{F,akt}/ψ_{F,akt} of the vehicle.

The current position x_{F,akt}/y_{F,akt} of the vehicle remains unchanged during the determination of the two limiting rotational angles ψ_{F,max}, ψ_{F,min}. The vehicle 10 is, so to speak, rotated virtually about its vertical axis in this position until the relevant limiting rotational angle is reached from which it is still just possible to determine a trajectory—which means a possible travel path of the vehicle 10—specifically the relevant limiting trajectory 23 or 24 to the target position 17.

First of all, we will assume that the vehicle is rotated to the right about its vertical axis (in the mathematically negative sense) until the current rotational angle ψ_{F,akt} is reduced by Δψ_{R} so that the vehicle longitudinal axis assumes the position designated by 71′ in FIG. 6a. The vehicle longitudinal axis 71′ forms the lower limiting rotational angle ψ_{F,min} with the y axis of the coordinate system 22. The right-hand limiting trajectory 23 resulting in this vehicle position, viewed in the direction of travel 18 of the driving maneuver, is illustrated in FIG. 6a.

Equally, the vehicle 10 can be rotated virtually to the left about its vertical axis (in the mathematically positive sense) in its current vehicle position until the left-hand limiting trajectory 24 to the target position 17 is just still possible. The current rotational angle ψ_{F,akt} has in this case been increased by Δψ_{L} so that between the vehicle longitudinal axis designated by 71″ in this rotational position and the y-axis of the coordinate system 22, the upper limiting rotational angle ψ_{F,max} results. In this way, a rotational angle tolerance range between the lower limiting rotational angle ψ_{F,min} and the upper limiting rotational angle ψ_{F,max} is calculated.

This rotational angle tolerance range is then used to determine the vehicle longitudinal velocity v by using a function f which, in principle, can be selected as desired. In this case, the vehicle longitudinal velocity v depends on the steering angle deviation dLw. If the value of the steering angle deviation d_{LW} lies within the steering angle correction range K, the actual steering angle δᵢₛₜ is corrected automatically and the vehicle longitudinal velocity v remains unchanged. However, if the steering angle deviation d_{LW} remains outside the steering angle correction range K, the vehicle longitudinal velocity is decreased in order to give the driver sufficient time to predefine an acceptable actual steering angle δᵢₛₜ again by means of the steering wheel position.

An example of the dependence of the vehicle longitudinal velocity v on the actual steering angle δᵢₛₜ is plotted in FIG. 6b. If the driver of the vehicle sets, by means of the steering wheel position, an actual steering angle δᵢₛₜ, which corresponds to the setpoint steering angle δₛₒₗₗ to be set, the vehicle longitudinal velocity v=v₀. In order to predefine the setpoint steering angle δₛₒₗₗ, the steering angle correction range K is predefined. If the driver sets an actual steering angle δᵢₛₜ which lies within the steering angle correction range K and therefore deviates only slightly from the setpoint steering angle δₛₒₗₗ, the vehicle longitudinal velocity v remains unchanged. In the case of steering angle deviation d_{LW} which lie within the steering angle correction range K, a driver-independent steering angle correction of the actual steering angle δᵢₛₜ takes place so that it is not necessary to influence the longitudinal dynamics of the vehicle. Within the steering angle correction range K, the vehicle longitudinal velocity v is therefore v=v₀.

This steering angle correction range K constitutes, in the example according to FIG. 6b, the apex region of a Gaussian-like curve, the apex point lying at the value pair δₛₒₗₗ/v₀. The steering angle correction range K is predefined, for example, so as to be symmetrical with the steering angle setpoint value δₛₒₗₗ, but an asymmetrical selection could alternatively also be made.

This curve is of a symmetrical design with respect to a parallel line to the v axis through the apex point. For example, each of the two curved sections 80 or 81 which result by dividing the curve at the apex point is dependent on the rotational angle difference Δψ_{R} or Δψ_{L} between the current rotational angle ψ_{F,akt} and the corresponding upper or lower limiting rotational angle ψ_{F,max} or ψ_{F,min}. The first curved section 80 between the setpoint steering angle δₛₒₗₗ and smaller actual steering angles δᵢₛₜ is determined in such a way that the standard deviation corresponds to the rotational angle difference Δψ_{R} between the lower limiting rotational angle ψ_{F,min} and the current vehicle rotational angle ψ_{F,akt}. In an analogous fashion, the second curved section 81 is determined starting from the setpoint steering angle δₛₒₗₗ in the direction of relatively large actual steering angles δᵢₛₜ in such a way that the location deviation of this second curved section 81 corresponds to the rotational angle difference Δψ_{L} between the upper limiting rotational angle ψ_{F,max} and the current vehicle rotational angle ψ_{F,akt}.

A minimum acceptable actual steering angle δₘᵢₙ and a maximum acceptable actual steering angle δₘₐₓ are then obtained from these two curved sections 80, 81. As is apparent from FIG. 6b, the difference between the setpoint steering angle δₛₒₗₗ and the minimum acceptable actual steering angle δₘᵢₙ is smaller than the difference between the maximum acceptable actual steering angle δₘₐₓ and the setpoint steering angle δₛₒₗₗ. Correspondingly, the longitudinal velocity v of the vehicle given a deviating actual steering angle δᵢₛₜ which is smaller than the setpoint steering angle δₛₒₗₗ is decreased to a greater extent than would be the case given a corresponding deviation from the setpoint steering angle δₛₒₗₗ in the direction of relatively large actual steering angles δᵢₛₜ.

This can clearly be explained by the fact that when there is a change in the rotational angle of the vehicle in the mathematically positive sense a larger tolerance range is available than when the current rotational angle of the vehicle changes in the mathematically negative sense (cf. FIG. 6a).

As soon as the driver sets an actual steering angle δᵢₛₜ which, when the vehicle 10 continues to travel, would lead to a situation in which the vehicle 10 assumes a vehicle position from which it is impossible to find a trajectory to the target position 17, the vehicle is brought to a stationary state. The vehicle is then accelerated again independently of the driver only when the driver sets an actual steering angle δᵢₛₜ which lies between the minimum acceptable actual steering angle δₘᵢₙ and the maximum acceptable actual steering angle δₘₐₓ

In one particularly advantageous embodiment, whenever the vehicle has been decelerated automatically to a stationary state the reference trajectory is calculated anew.

As an alternative to using a Gaussian-like curve it would also be possible to use a triangular function or any other desired curved form with the apex point δₛₒₗₗ/v₀. This function may in particular be acquired empirically in driving trials in order to set the desired driving sensation.

In the exemplary embodiment, the longitudinal velocity v of the vehicle is regulated as a function of the actual steering angle δᵢₛₜ or the steering angle deviation d_{LW}. This is done by actuating deceleration means 50 and/or propulsion means 51 of the vehicle 10.

The deceleration means 50 are formed in the exemplary embodiment according to FIG. 2 by a brake device 52 with a brake control unit 53 and wheel brake devices 54 which are actuated by this brake control unit 53 and which are assigned to the vehicle wheels 55 of the rear axle of the vehicle, and wheel brake devices 56 which are assigned to the vehicle wheels 34 of the front axle 35 of the vehicle 10. In order to actuate the brake device 52, the evaluation device 12 is connected to the brake control unit 53. If consequently the current setpoint trajectory 19 approaches one of the limiting trajectories 23, 24, the evaluation device 12 actuates the brake control unit 53 which in turn acts on one or more of the wheel brake devices 54, 56.

As an alternative to performing closed-loop control of the velocity, when a steering angle deviation d_{LW} which lies outside the steering angle correction range K is present the longitudinal velocity v of the vehicle can be reduced starting from the maximum velocity v₀, which can be approximately 5 km/h, by bringing about a brake pressure or a braking force only by means of an open-loop control process, without adjusting the velocity to a setpoint value by means of closed-loop control.

As an alternative to or at the same time as the actuation of the brake device 52, the propulsion means 51 are actuated in order to decelerate the vehicle. For this purpose, the evaluation device 12 is connected to the engine control unit 60 which is illustrated schematically in FIG. 2 and which symbolizes the propulsion means 51 here. For reasons of clarity, the entire drive train with the engine control unit 60, the vehicle engine, the transmission, the drive shaft etc. was not illustrated.

In a modified form the method according to the invention can also be used for driving maneuvers of the vehicle 10 with a trailer 70. In such a case it is alternatively or additionally possible, for the purpose of influencing the longitudinal velocity v of the vehicle as a function of the steering angle deviation d_{LW} lying outside the steering angle correction range K, also to influence the longitudinal velocity v of the vehicle as a function of the bending angle deviation between a setpoint bending angle βₛₒₗₗ and a current bending angle βₐₖₜ. As in the case of the steering angle, interventions are also made into the longitudinal dynamics of the vehicle 10 when there is a bending angle deviation only if the value of the bending angle deviation lies outside a predefined bending angle correction range. Within this bending angle correction range the deviation of the bending angle is corrected or compensated for by automatic, driver-independent steering interventions.

The bending angle β is formed between the vehicle longitudinal axis 71 and the trailer longitudinal axis 72 (see FIG. 7). Owing to the better clarity, the trailer coupling and the trailer shafts for connecting the vehicle 10 to the trailer 70 are not illustrated in FIG. 7.

In the trailer mode, each vehicle position of the vehicle 10 to be passed through along the reference trajectory 16 is assigned a corresponding setpoint bending angle βₛₒₗₗ. The simplest example would be movement of the vehicle 10 with the trailer 70 straight backward so that the setpoint bending angle βₛₒₗₗ is zero during the entire driving maneuver.

The vehicle 10 has means for determining the setpoint bending angle βₛₒₗₗ which are contained, for example, in the evaluation device 12. Furthermore, the vehicle 10 and/or the trailer 70 has/have means for determining the current bending angle βₐₖₜ, said means not being illustrated here in more detail. For example, the bending angle between the vehicle 10 and the trailer 70 can be sensed by bending angle sensors which are known per se.

During the driving maneuver, the steering wheel position which the driver has to set in order for the currently sensed bending angle βₐₖₜ to correspond to the setpoint bending angle βₛₒₗₗ is then indicated to the driver. If the current bending angle βₐₖₜ differs from the setpoint bending angle βₛₒₗₗ, firstly steering interventions are performed in order to correct the deviation. If the bending angle deviation lies outside the predefined bending angle correction range, the deceleration means 50 and/or the propulsion means 51 of the vehicle 10 are actuated independently of the driver in order to reduce the longitudinal velocity v of the vehicle. The greater the bending angle deviation between the current bending angle βₐₖₜ and the setpoint bending angle βₛₒₗₗ, the greater the automatically brought-about braking force or the braking pressure p or the deceleration of the vehicle. It is also possible to perform closed-loop control of the longitudinal velocity v of the vehicle as a function of the bending angle deviation between the setpoint bending angle βₛₒₗₗ and the current bending angle βₐₖₜ, in which case the setpoint velocity vₛₒₗₗ is lower the greater the bending angle deviation between the current bending angle βₐₖₜ and the setpoint bending angle βₛₒₗₗ.

The assistance method for driving maneuvers in the trailer mode as a function of the bending angle β can also be carried out independently of the determination of a reference trajectory. For example, in the case of a driving maneuver straight backward with trailer 70, it is possible for only the bending angle deviation between the setpoint bending angle βₛₒₗₗ and the current bending angle βₐₖₜ to be taken into account in order to determine the steering wheel angle to be set.

If each position of the vehicle 10 and of the trailer 70 is assigned a corresponding setpoint bending angle βₛₒₗₗ along the reference trajectory for relatively complex driving maneuvers in the trailer mode, the feedback for the driver by means of the steering wheel angle to be set and the automatic actuation of the deceleration means 50 and/or propulsion means 51 takes into account both the steering angle deviation d_{LW} and the bending angle deviation.

1-14. (canceled)

15. A method for assisting the driver of a vehicle during a driving maneuver, a reference trajectory corresponding to the driving maneuver being determined, the vehicle to be moved along the reference trajectory during the driving maneuver, the steering wheel position to be respectively set to steer the vehicle along the reference trajectory being indicated to the driver during the driving maneuver, the method comprising:
correcting, independently of the driver, a steering angle deviation between an actual steering angle actually set by the driver and a setpoint steering angle corresponding to the indicated steering wheel position, the driver-independent correction of the steering angle deviation taking place only if the steering angle deviation lies within a predefined steering angle correction range.

16. The method as recited in claim 15 further comprising influencing a longitudinal velocity of the vehicle independently of the driver when the steering angle deviation lies outside the steering angle correction range.

17. The method as recited in claim 16 wherein the velocity of the vehicle is influenced as a function of an absolute value of the steering angle deviation.

18. The method as recited in claim 16 further comprising determining a steering angle tolerance range defining the permissible steering angles, the determining occurring during the driving maneuver as a function of a current position of the vehicle, the influencing of the longitudinal velocity depending on a tolerance interval between the setpoint steering angle and limits of the tolerance range.

19. The method as recited in claim 18 further comprising determining a rotational angle tolerance range to acquire the steering angle tolerance range, a current rotational angle between a longitudinal axis of the vehicle and a coordinate axis of a fixed coordinate system being increased or decreased to points where it remains possible to determine a trajectory with respect to a target position.

20. The method as recited in claim 17 in that a smaller value is selected for the vehicle longitudinal velocity the larger the absolute value of the steering angle deviation or the smaller an absolute value of a steering angle tolerance interval.

21. The method as recited in claim 16 further comprising decelerating the vehicle to a stationary state and holding the vehicle in the stationary state as long as, owing to the steering angle deviation currently present, the vehicle would, when continuing to travel, assume a vehicle position where a target position can no longer be reached without interrupting a positioning of the driving maneuver.

22. The method as recited in claim 21 further comprising accelerating the vehicle again independently of the driver if the driver sets the steering wheel position to lead to the steering angle deviation being acceptable or being capable of being corrected independently of the driver.

23. The method as recited in claim 15 wherein the steering wheel position to be set is indicated by providing audible information to the driver or providing visual information to the driver or providing haptic information to the driver.

24. The method as recited in claim 23 wherein the providing of haptic information to the driver includes changing a steering wheel torque to be applied by the driver.

25. The method as recited in claim 15 wherein the driving maneuver is a parking maneuver and the reference trajectory indicates an ideal path from a current position of the vehicle to the parked position.

26. The method as recited in claim 15 wherein, in the case of a vehicle in a trailer mode, each position of the vehicle along a current reference trajectory is assigned a setpoint bending angle between a longitudinal axis of the vehicle and a longitudinal axis of the trailer, and a current bending angle is determined and is compared with the corresponding setpoint bending angle, a longitudinal velocity of the vehicle being influenced independently of the driver when an angular deviation exists between the setpoint bending angle and the current bending angle.

27. A device for carrying out the method for assisting the driver during the driving maneuver as recited in claim 15, the device comprising:
an evaluation device determining the reference trajectory corresponding to the driving maneuver and the steering angle deviation;
means for indicating the steering wheel position to be set by the driver; and
steering means for steering the vehicle along the reference trajectory and correcting the steering angle deviation detected by the evaluation device, the steering means being actuable independently of the driver.

28. A vehicle comprising:
vehicle wheels having a steering angle;
a steering wheel connected to the vehicle wheels and influencing the steering angle;
a steering assistance device connected to the vehicle wheels and influencing the steering angle;
an indicator for indicating a reference trajectory of the vehicle corresponding to a driving maneuver;
an evaluation unit determining a steering angle deviation between an actual angle of the steering wheel and a setpoint angle corresponding to the reference trajectory, the evaluation unit controlling the steering assistance device independently of the driver when the steering angle deviation is less than a predefined angle so that the steering angle is set to the setpoint angle.
